(19) United States
(12) Patent Application Publication
(10) Pub. No.: US 2006/0009603 A1
(43) Pub. Date: Jan. 12, 2006

(54) Fibrillation-resistant polypropylene tape

(76) Inventors: David Young, Deer Park, TX (US); Mohan R. Gownder, Austin, TX (US); Rob Rowland, Seabrook, TX (US)

Correspondence Address: David J. Alexander;Fina Technology Inc., P O Box 674412, Houston, TX, 77267-4412, US

(21) Appl. No.: 10/888,152

(22) Filed: Jul. 9, 2004

(51) Int. Cl. C08F 110/00

(52) U.S. Cl. 526/348.1; 526/351; 264/146; 264/160; 264/211.12

(57) ABSTRACT

The present invention relates to fibrillation resistant polypropylene tape formed from the polymerization of propylene utilizing isospecific metallocene catalysts. The resulting polymerized isotactic polypropylene is heated, extruded and withdrawn as a film or sheet. The sheet is then slit longitudinally into tape segments and drawn in the longitudinal direction to a draw ratio of at least about 4.5:1 to produce an oriented tape. It has been found that these polypropylene tapes have improved resistance to fibrillation than those polypropylene tapes produced using Ziegler-Natta catalyst drawn at the same draw ratios.

### FIELD OF THE INVENTION

This invention relates to polyolefin tapes, and more particularly to isotactic polypropylene tapes having improved resistance to fibrillation.

### BACKGROUND OF THE INVENTION

The polymers normally employed in the preparation of polypropylene oriented films and tapes are isotactic polymers, although on some occasions the use of syndiotactic polymers has been proposed. Isotactic polypropylene is one of a number of crystalline polymers that can be characterized in terms of the stereoregularity of the polymer chain. Various stereo-specific structural relationships denominated primarily in terms of syndiotacticity and isotacticity may be involved in the formation of stereoregular polymers for various monomers.

Isotactic polypropylene is conventionally used in the production of relatively thin tapes in which the polypropylene is heated and then extruded through dies as a sheet or film that is cut into tape segments and then subjected to orientation by stressing the tape in a longitudinal direction (referred to as the machine direction). The structure of isotactic polypropylene is characterized in terms of the methyl group attached to the tertiary carbon atoms of the successive propylene monomer units lying on the same side of the main chain of the polymer. That is, the methyl groups are characterized as being all above or below the polymer chain. Isotactic polypropylene can be illustrated by the following chemical formula: 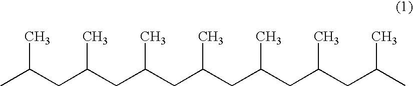
Another way of describing the structure is through the use of NMR. Bovey's NMR nomenclature for an isotactic pentad is . . . mmmm . . . with each “m” representing a “meso” dyad, of successive methyl groups on the same side of the plane of the polymer chain. As is known in the art, any deviation or inversion in the structure of the chain lowers the degree of isotacticity and crystallinity of the polymer.

Isotactic polymers are semi-crystalline and are insoluble in xylene. This crystallinity distinguishes isotactic polymers from an atactic polymer, which is non-crystalline and highly soluble in xylene. An atactic polymer exhibits no regular order of repeating unit configurations in the polymer chain and forms essentially a waxy product. In most cases, the preferred polymer configuration for oriented propylene films and tapes will be a predominantly isotactic or syndiotactic polymer with very little atactic polymer.

The isotactic polymers normally employed in the preparation of oriented polypropylene tapes are usually those prepared through the use of conventional Ziegler-Natta catalysts of the type disclosed, for example, in U.S. Pat. Nos. 4,298,718 and 4,544,717, both to Mayr et al. U.S. Pat. No. 5,573,723 to Peiffer et al discloses a process for producing biaxially-oriented polypropylene film based on an isotactic polypropylene homopolymer or propylene/ethylene co-polymers produced by catalysis with such conventional Ziegler-Natta catalysts. Other co-polymers of propylene and alpha-olefins having from 4-8 carbon atoms also may be employed in the Peiffer process.

Catalysts employed in the polymerization of alpha-olefins may be characterized as supported catalysts or unsupported catalysts, sometimes referred to as homogeneous catalysts. Traditional supported catalysts are the so-called “conventional” (or “standard”) Ziegler-Natta catalysts, such as titanium tetrachloride supported on an active magnesium dichloride as disclosed, for example, in the aforementioned patents to Mayr et al. A supported catalyst component, as disclosed in the Mayr '718 patent, includes titanium tetrachloride supported on an “active” anhydrous magnesium dihalide, such as magnesium dichloride or magnesium dibromide. The supported catalyst component in Mayr '718 is employed in conjunction with a co-catalyst such as an alkylaluminum compound, for example, triethylaluminum (TEAL). The Mayr '717 patent discloses a similar compound, which may also incorporate an electron donor compound that may take the form of various amines, phosphenes, esters, aldehydes, and alcohols. Metallocene catalysts are often employed as unsupported or homogeneous catalysts, although, as described below, they also may be employed in supported catalyst components.

Alternative types of catalysts that produce isotactic polyolefins are disclosed in U.S. Pat. Nos. 4,794,096 and 4,975,403. These patents disclose chiral, stereorigid metallocene catalysts that polymerize olefins to form isotactic polymers and are especially useful in the polymerization of highly isotactic polypropylene. As disclosed, for example, in the aforementioned U.S. Pat. No. 4,794,096, stereorigidity in a metallocene ligand is imparted by means of a structural bridge extending between cyclopentadienyl groups. Specifically disclosed in this patent are stereoregular hafnium metallocenes which may be characterized by the following formula:
R″(C₅(R′)₄)₂ HfQp (2)
In formula (2), (C₅(R′)₄) is a cyclopentadienyl or substituted cyclopentadienyl group, R′ is independently hydrogen or a hydrocarbyl radical having 1-20 carbon atoms, and R″ is a structural bridge extending between the cyclopentadienyl rings. Q is a halogen or a hydrocarbon radical, such as an alkyl, aryl, alkenyl, alkylaryl, or arylalkyl, having 1-20 carbon atoms and p is 2.

The various metallocene structures as described above can be used either as so-called “neutral metallocenes” in which case an alumoxane, such as methylalumoxane, is used as a co-catalyst, or they can be employed as so-called “cationic metallocenes” which incorporate a stable non-coordinating anion and normally do not require the use of an alumoxane. For example, syndiospecific cationic metallocenes are disclosed in U.S. Pat. No. 5,243,002 to Razavi. As disclosed there, the metallocene cation is characterized by the cationic metallocene ligand having sterically dissimilar ring structures that are joined to a positively-charged coordinating transition metal atom. The metallocene cation is associated with a stable non-coordinating counter-anion. Similar relationships can be established for isospecific metallocenes.

While metallocene catalysts are generally proposed for use as homogeneous catalysts, it is also known in the art to provide supported metallocene catalysts. As disclosed in U.S. Pat. Nos. 4,701,432 and 4,808,561, both to Welborn, a metallocene catalyst component may be employed in the form of a supported catalyst. As described in the Welborn '432 patent, the support may be any support such as talc, an inorganic oxide, or a resinous support material such as a polyolefin. Specific inorganic oxides include silica and alumina, used alone or in combination with other inorganic oxides such as magnesia, zirconia, and the like. Non-metallocene transition metal compounds, such as titanium tetrachloride, are also incorporated into the supported catalyst component. The Welborn '561 patent discloses a heterogeneous catalyst that is formed by the reaction of a metallocene and an alumoxane in combination with the support material. Various other catalyst systems involving supported metallocene catalysts are disclosed in U.S. Pat. No. 5,308,811 to Suga et al and U.S. Pat. No. 5,444,134 to Matsumoto.

Oriented polypropylene tapes are used in a variety of applications. They can be used in such applications as forming carpet backing, trampoline fabric, bale wrap, geotextiles, film for packaging and filtration media. To form such materials, the polypropylene tapes must undergo a variety of mechanical processing operations, such as occurs during weaving. It is therefore important that the tapes be able to withstand these operations without degrading or becoming damaged. One of the things that occurs with many oriented tapes is fibrillation. Fibrillation occurs when the tape begins to crack or split along its length into fiber-like elements. As described in Olson et al., U.S. Pat. No. 4,129,632, oriented polymer tapes or ribbons may be intentionally fibrillated and then wound into cordage, which is then used for yarn, twine or textile materials. Other tapes, however, are not fibrillated, but are used as whole tapes that are woven or otherwise formed into desired products. In these cases, resistance to fibrillation is important. With continued handling and processing, such as during weaving, mechanical stresses on the tapes can result in the tapes becoming fibrillated. Excessive fibrillation of the tapes can result in an inferior final product and downtime during manufacturing processes, when defective tapes must be replaced. It is therefore desirable to minimize or eliminate the tendency of these oriented tapes to fibrillate.

### SUMMARY OF THE INVENTION

A fibrillation resistant polymer tape is formed from (a) an elongated tape segment prepared by the process of i) heating and extruding an isotactic propylene polymer produced by the polymerization of propylene in the presence of an isospecific metallocene catalyst to produce an isotactic polypropylene film; and ii) forming the film into at least one tape segment by drawing the tape segment in at least one direction at a draw ratio of at least about 4.5:1. This tape segment is characterized by a lateral resistance to fibrillation that is greater than the lateral resistance to fibrillation of a tape segment produced under the same conditions as specified above, from an isotactic polypropylene produced by a supported Ziegler-Natta catalyst comprising titanium tetrachloride on a magnesium chloride support having a titanium content of 2.5 wt. %. The supported Ziegler-Natta catalyst is further characterized as having an internal electron donor in the form of a diester of phthalic acid, specifically n-butyl phthalate and an external electron donor in the form of cyclohexylmethyldimethoxysilane (CMDS). The catalyst system is employed with a cocatalyst in the form of triethyl aluminum (TEAL) to provide a catalyst system having an aluminum/titanium molar ratio of 200. The isotactic polypropylene produced by the Ziegler-Natta catalyst has an isotacticity of 96% mmmm pentads as measured on the crystalline fraction (xylene insoluble, heptane insoluble) and a xylene-soluble content of 2 wt. %. Ziegler-Natta catalyst systems of the type thus described and their use in the polymerization of propylene to produce isotactic polypropylene are disclosed in U.S. Pat. No. 4,927,797, the entire disclosure of which is incorporated herein by reference.

In a preferred embodiment of the invention, the isospecific metallocene catalyst is characterized by the formula:
R″(C₅(R′)₄)₂MeQₖ (3)
wherein each (C₅(R′)₄) is a substituted cyclopentadienyl ring; each R′ is the same or different and is a hydrogen or hydrocarbyl radical having 1-20 carbon atoms; R″ is a structural bridge between the two (C₅(R′)₄) rings being in a racemic configuration relative to Me, and R″ is selected from the group consisting of an alkylene radical having 1-4 carbon atoms, a silicon hydrocarbyl radical, a germanium hydrocarbyl radical, a phosphorus hydrocarbyl radical, a nitrogen hydrocarbyl radical, a boron hydrocarbyl radical, and aluminum hydrocarbyl radical; Me is a group 4, 5 or 6 transition metal as designated in the Periodic Table of Elements; each Q is a hydrocarbyl radical having 1-20 carbon atoms or is a halogen; and 0≦k≦3.

In another preferred embodiment, the drawn tape segment may have a width within the range of about 0.1 cm to about 0.5 cm, and in another preferred embodiment may have a thickness from about 200 to 5000 denier.

### BRIEF DESCRIPTION OF THE DRAWINGS

FIG. 1A is a diagram reflecting a front section of an exemplary Bouligny process line for producing oriented slit-film tapes.

FIG. 1B is a diagram reflecting a later section of the Bouligny process line, which is a continuation of that shown in FIG. 1A.

FIG. 2 is a graph showing the percentage of elongation at break plotted on the ordinate versus the draw ratio plotted on the abcissa for polymer tapes produced with both metallocene and Ziegler-Natta catalysts.

FIG. 3 is a graph showing the tenacity at maximum elongation plotted on the ordinate versus the draw ratio plotted on the abcissa for polymer tapes produced with both metallocene and Ziegler-Natta catalysts.

FIG. 4 is a graph showing the tenacity at 5% elongation plotted on the ordinate versus the draw ratio plotted on the abcissa for polymer tapes produced with both metallocene and Ziegler-Natta catalysts.

FIG. 5 is a graph showing the modulus at 5% elongation plotted on the ordinate versus the draw ratio plotted on the abcissa for polymer tapes produced with both metallocene and Ziegler-Natta catalysts.

FIG. 6 is graph showing the percentage of shrinkage plotted on the ordinate versus the draw ratio plotted on the abcissa for polymer tapes produced with both metallocene and Ziegler-Natta catalysts.

### DETAILED DESCRIPTION OF THE INVENTION

The present invention involves the use of isotactic polypropylene polymerized in the presence of metallocene catalysts to make fibrillation resistant tapes. It has been found that isotactic polypropylene tapes formed from propylene polymerized in the presence of an isospecific metallocene catalyst have improved resistance to fibrillation in comparison to Ziegler-Natta isotactic polypropylene when extruded and drawn up to and beyond the typical draw ratios commonly used for Ziegler-Natta isotactic polypropylene.

Polymers used in forming oriented tapes are characterized in terms of certain well-defined characteristics relating to their stereoregular structures and physical properties, including melt temperatures and shrinkage characteristics, as well as in relatively low coefficients of friction and relatively high tensile moduli. The present invention addresses tapes prepared from isotactic polypropylene, preferably as a homopolymer. The isotactic polypropylene is prepared by the polymerization of an olefin monomer using an isospecific metallocene, as is discussed below. A further application of the present invention would use isotactic polypropylene as a primary component either in an ethylene-propylene copolymer or in combination with atactic or syndiotactic polypropylene homopolymer. For copolymers of propylene and ethylene, ethylene is usually used in an amount ranging from about 0.5 to 6% by weight ethylene.

The polymerized mixture will often further include minor amounts (typically less than 1 wt. %, and more typically less than 0.5 wt. %) of additives designed to enhance other physical or optical properties. Such mixtures may have, for example, one or more anti-oxidants present in an amount totaling no more than about 0.25 wt. % (in the tested examples no more than about 0.15 wt. %) and one or more acid neutralizers present in an amount totaling no more than about 0.25 wt. %. Although not present in the tested examples, additives acting as “anti-blocking” agents may also be present, again in relatively low percentages such as no more than about 1 wt. %, more preferably no more than about 0.5 wt. %, and even more preferably no more than about 0.25 wt. %.

As discussed, the present invention involves a fibrillation resistant tape prepared by the use of a metallocene catalyst to polymerize propylene, more particularly isotactic polypropylene. Those isospecific metallocene catalysts for use in preparing isotactic polypropylene and having application to the present invention can be characterized by the following formula:
R″(C₅(R′)₄)₂MeQₖ (3)
wherein each (C₅(R′)₄) is a substituted cyclopentadienyl ring. Each R′ is the same or different and is a hydrogen or hydrocarbyl radical having 1-20 carbon atoms. R″ is a structural bridge between the two(C₅(R′)₄) rings which are in a racemic configuration relative to Me.

Another more specific formula for the isospecific metallocene catalyst is represented by the formula:
R″(Ind)₂MeQₖ (4)
wherein Ind is an indenyl or substituted indenyl group in a racemic configuration. In both Formulas (3) and (4), R″ is a structural bridge extending between the cyclopentadienyl rings. Me is a coordinated transition metal, which may be a Group 4, 5, or 6 transition metal from the Periodic Table of Elements, but preferably is a Group 4 or 5 metal, and more preferably a Group 4 metal, specifically titanium, zirconium, or hafnium. Vanadium is the most suitable of the Group 5 metals. For the present invention, zirconium is the most preferred transition metal. Q is an alkyl or other hydrocarbyl radical having 1-20 carbon atoms or a halo group, and k is a number from 0 to 3.

U.S. Pat. No. 4,794,096 discloses various possible structures R″ for the structural bridge. R″ is a stable component that bridges the two (C₅(R′)₄) rings in order to render the catalyst stereorigid. R″ may be organic or inorganic and may include groups substituted on the portion of R″ acting as a bridge. Examples of R″ include an alkylene radical having 1-4 carbon atoms, a silicon hydrocarbyl group, a germanium hydrocarbyl group, an alkyl phosphine, an alkyl amine, boron, nitrogen, sulfur, phosphorous, aluminum or groups containing these elements. The preferred R″ components are methylene, ethylene, an dialkyl silicon, and a cycloalkyl silicon such as cyclopropyl silicon, among others. For the present invention, a suitable silicon bridge structure is dimethyl silyl. The metallocene or mixtures of two or more metallocenes may be supported on a particulate catalyst support. European Patent Application EP 856,525, the entire disclosure of which is herein incorporated by reference, describes a suitable method of providing a supported metallocene catalyst.

The metallocene or metallocene mixture catalyst systems employed in the present invention are used in combination with an alumoxane co-catalyst, as will be well understood by those skilled in the art. Normally, methylalumoxane will be employed as a co-catalyst, but various other alumoxanes, such as ethylalumoxane and isobutylalumoxane, may be employed in lieu of or in conjunction with methylalumoxane. The use of such co-catalysts in metallocene-based catalyst systems are well-known in the art, as disclosed, for example, in U.S. Pat. No. 4,975,403 to Ewen, the entire disclosure of which is incorporated herein by reference. So-called alkylaluminum co-catalysts or scavengers are also normally employed in combination with the metallocene alumoxane catalyst systems. Suitable alkylaluminum or alkylaluminum halides include trimethylaluminum, triethylaluminum (TEAL), triisobutylaluminum (TIBAL), and tri-n-octylaluminum (TNOAL). Mixtures of such co-catalysts may also be employed in carrying out the present invention. While trialkylaluminums will usually be used as scavengers, it is to be recognized that alkylaluminum halides, such as diethylaluminum chloride, diethylaluminum bromide, and dimethylaluminum chloride, or dimethylaluminum bromide, may also be used in the practice of the present invention.

U.S. Pat. No. 4,129,632 to Olson et al. describes a method of manufacturing oriented tapes. In manufacturing oriented tapes, the polymer or polymers used to make the film, which is eventually slit into tape segments, are melted and then passed through an extruder to a slot die mechanism after which it is either passed through a quench tank, or passed over a first roller, characterized as a chill roller, either of which tends to solidify the film. This cooling or quenching is typically used to cool the extruded polymer to a suitable temperature within the range of about 75 to 120° F. The timing of the extrusion and cooling or quenching process is in part governed by the “take-away” speed at which the first exterior roller is withdrawing the film or sheet from the extruder through the cooling or quenching section. There is also commonly a relaxation of 5%-25% allowed for between the take-away roller (or rollers) and the first drawing rollers (which travel 5-25% faster), allowing the film to relax and expand slightly without sagging or becoming loose. The film is slit after extrusion and quenching into longitudinal segments. This may be accomplished by any number of slitting methods known in the art, including those disclosed in the aforementioned patent to Olson et al. The film is slit into tape segments having widths that account for the subsequent orientation, wherein the widths of the tapes are reduced further. Typical tape widths for the present invention prior to drawing may be between 0.3 to 1.0 centimeter.

The tape segments are then oriented by drawing in a longitudinal direction, typically under heated conditions, to arrive at tape segments which can be characterized in terms of an orientation ratio, sometimes also referred to as the draw or stretch ratio. Unless otherwise specified, all references to “draw,” “draw ratio,” “stretch” or “stretch ratio” refer to the stretching or drawing of the polypropylene tape in the longitudinal or machine direction. The longitudinal or machine direction orientation may be accomplished through the use of two sequentially disposed rollers, the second or fast roller operating at a speed in relation to the slower roller corresponding to the desired orientation ratio. This may alternatively be accomplished through a series of rollers with increasing speeds, sometime with additional intermediate rollers for temperature control and other functions. After the tapes have been stressed in the machine direction, it may be heated on an annealing roll to reduce later shrinkage. In stretching the tape in the machine direction, it is heated by heated rollers or an oven within the temperature range of about 250-450° F., with an incremental temperature increase of about 140-210° F. During drawing, the slow roller (typically referred to as Godet 1) may be operated at any suitable speed, usually about 10 to 60 meters per minute in a production line. The fast roller (typically referred to as Godet 2) is operated at a suitable speed, typically approaching 120 to 360 meters per minute in a production line, to provide a surface speed at the circumference of about three or more times that of the slow roller in order to orient the tape in the machine direction. The oriented tapes may be from 200 to 5000 denier, with 750 to 1250 denier being preferred in most applications.

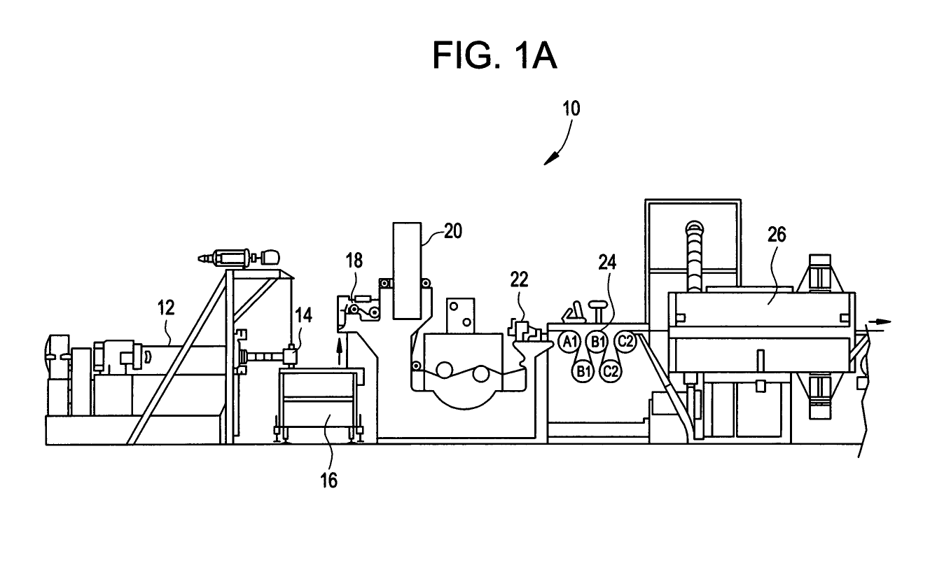

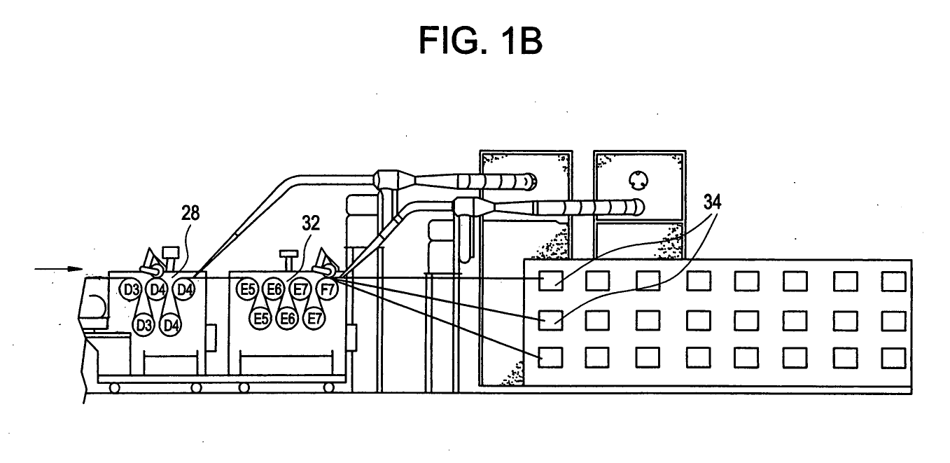

While the aforementioned Olson patent discloses that the slit tapes are then fibrillated, the tapes of the present invention typically are not, and in contrast, exhibit improved resistance to fibrillation. In any case, the tapes are typically wound onto bobbins or take-up rolls or reels. FIGS. 1A and 1B show a Bouligny slit film process line 10 that may be used in forming the oriented tapes of the invention. The process line 10 is provided with an extruder 12 in which the polypropylene is extruded at high temperature and pressure into a thin sheet or film through a die head 14. The extruded sheet is immediately passed to a quench tank 16 where it is taken up by take-away rolls 18. It should be noted that some orientation or drawing may occur during these initial stages as tension is applied to the extruded film by the take-away rolls. A thickness gage 20 is provided downstream to measure any variations of thickness in the film to ensure uniform film thickness. The film is eventually passed to a cutter 22 where the film is slit longitudinally into a plurality of tape segments, which are then passed through a series of rollers 24. The rollers 24 may be heated to provide preheating prior to orientation. The rollers 24 may each be operated at different speeds to provide tension and some initial stretching of the tape. The tape segments are stretched or drawn primarily within the oven or heating section 26 as it is passed from the last roller or godet in the series 24 to the initial roller or godet of roller series 28 (FIG. 1B) located downstream from the oven 26. The rollers of roller series 28 may be heated or cooled to provide annealing of the oriented tape segments. Each roller may be heated or cooled to a selected temperature to provide a gradual temperature decrease. The tapes pass downstream from the roller series 28 to another roller series 32, which may also be heated or cooled if desired. The individual oriented tapes are then passed from the roller series 32 to individual winders or take-up reels 34, which can be periodically removed and replaced as they are filled.

As indicated by the following experimental work, improved resistance to fibrillation is obtained in the metallocene isotactic polypropylene tapes in comparison to those prepared from conventional Ziegler-Natta isotactic polypropylene at certain draw ratios indicated below. The following examples also provide an illustration of other physical and process properties of the metallocene isotactic polypropylene. It has been found that isotactic propylene polymer tapes prepared using a metallocene catalyst that were produced at particular take-away speeds showed improvements in certain processing conditions, such as extruder pressure, and in the resulting polymer tape. In the present invention, the rollers are operated at speeds to produce draw ratios of greater than at least 4.5:1, with draw ratios ranging between about 4.5:1 to 12:1 being preferred.

### EXAMPLE 1

Homopolymer resins of isotactic polypropylene were processed through a Bouligny slit-film line using different draw ratios and the resulting properties then measured. One of the resins was an isotactic polypropylene which had been prepared using a metallocene catalyst. The other resin was an isotactic polypropylene prepared using a Ziegler-Natta catalyst. Both polymer resins were then processed using the same production line.

The trial was conducted in a Bouligny slit film line where the screw speed of the extruder was adjusted to maintain approximately a 1,000 denier tape. The air gap was 12.7 millimeters, while the die gap was 0.38 millimeters. The extrusion temperature was approximately 250° C. The quench tank was maintained at about 38° C. The take away speeds were run alternatively at about 21 meters per minute in each run. The Godet 1 speed was at 23 meters per minute providing a relaxation of 3% from the take away speed of 21 meters per minute. Prior to drawing, the film was slit along its longitudinal (machine-direction) axis into individual tape segments (also called individual film segments or individual tapes) with widths of approximately ¼ inch. The tapes were run through a stretching oven, which was maintained at about 170° C., while annealing rolls were run at about 143° C. The tape was oriented in the longitudinal or machine direction with different draw ratios of between about 5:1 to 11:1. The polypropylene was maintained at a temperature of about 338° F. The tapes were then physically tested using an Instron Universal Testing Machine.

With respect to the polymer resins used, Sample 1 was generated by the polymerization of propylene over a metallocene catalyst composed of a mixture of racemic dimethylsilyl bis(2-methyl-4-phenyl indenyl)zirconium dichloride and dimethylsilyl bis(2-methyl indenyl)zirconium dichloride. Sample 1 had a measured melt flow index of 4.7 g/10 min with a xylene solubles content of 0.3%. Sample 2 was generated using a supported Ziegler-Natta catalyst in the form of titanium tetrachloride on a magnesium chloride support having a titanium content of 2.5 wt. %. The catalyst system employed had an internal electron donor of n-butyl phthalate and an external electron donor of cyclohexylmethyldimethoxysilane (CMDS). A TEAL co-catalyst was used to provide a catalyst system having an aluminum/silicon molar ratio of 200. The isotactic polypropylene produced by the Ziegler-Natta catalyst had an isotacticity of 96% mmmm pentads as measured on the crystalline fraction (xylene insoluble, heptane insoluble) and a xylene-soluble content of 2 wt. %. Sample 2 had a measured melt flow index of 4.9 g/10 mins with a xylene soluble content of 2 wt. %.

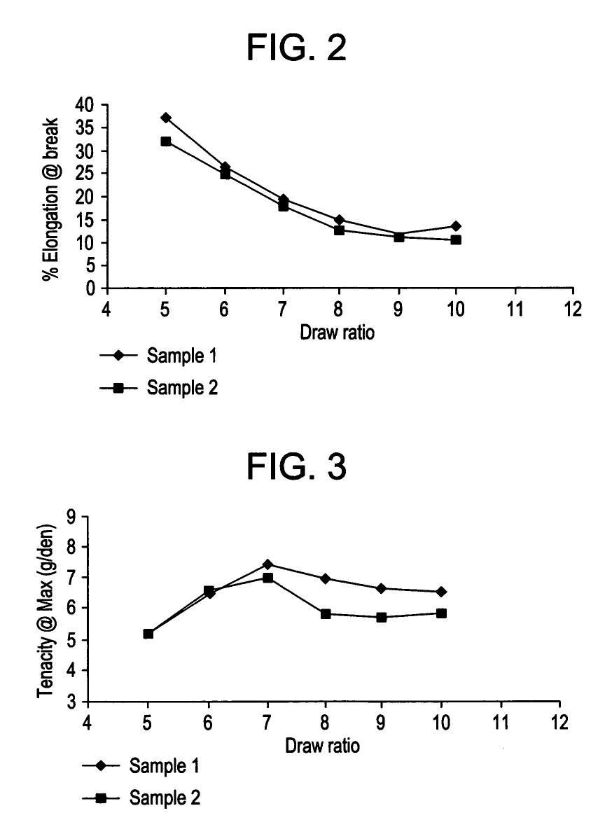

The characteristics of the polypropylene tapes produced from the Ziegler-Natta and metallocene polypropylenes are disclosed in FIGS. 2 through 6. In FIGS. 2 through 6, the data points for the metallocene polypropylene tape are indicated by ♦ and the Ziegler-Natta polypropylene tape by ▪. It was generally observed, as shown in FIG. 2, that the metallocene polypropylene tape of Sample 1 had a higher elongation at break for all draw ratios compared to the polypropylene tape of Sample 2, which was prepared with the Ziegler-Natta catalyst. The lowest elongation at break measured for the metallocene polypropylene tape was about 12.0% (FIG. 2) at a draw ratio of 9:1. Elongation at break up to as high as about 36.9% (draw ratio 5:1) were also recorded. Similar results were achieved for the metallocene polypropylene processed in another production line utilizing draw ratios of between 6:1 to 11:1.

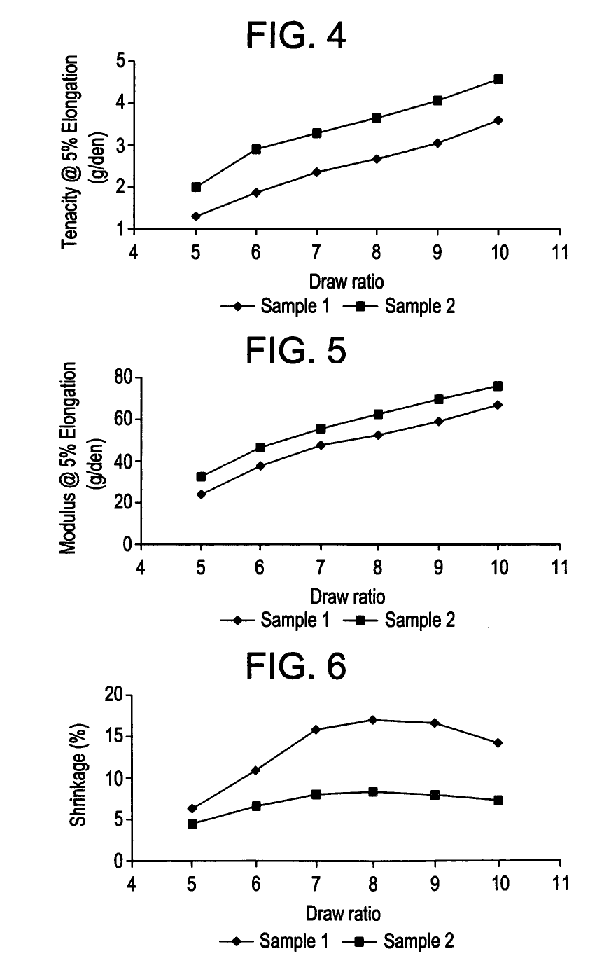

A fairly large difference in the tenacities of the two materials resulted at draw ratios greater than 7:1, with no drop off at these higher ratios. As shown in FIG. 3, the tenacity at maximum is slightly higher for the polypropylene of Sample 1 compared to the Ziegler-Natta polypropylene of Sample 2 at the same draw ratios, particularly at draw ratios above 8:1. This is particularly unexpected in view of the fact that the tenacity and modulus at relatively low elongations are substantially higher for the polypropylene tape based upon Ziegler-Natta catalyst than the tapes based upon metallocene catalysts. It is noted, that the tenacity and modulus at low elongations are considerably higher for the Ziegler-Natta sample, as shown in FIGS. 4 and 5. In no case did the tenacity at maximum elongation drop below 6 g/den for the polypropylene tape of the metallocene sample.

FIG. 6 shows the shrinkage data for the two compounds. At lower draw ratios, the shrinkage for both materials are closer together, but the differences increase at draw ratios higher than 6:1, with the shrinkage for metallocene polypropylene tape being greater. This is probably due to the presence of more amorphous orientation in the metallocene isotactic polypropylene, which is quick to relax at an elevated temperature. It is theorized that the higher molecular weight molecules in the Ziegler-Natta isotactic polypropylene, such as that of Sample 2, may act as tie molecules, which may interfere with the shrinkage.

In summary, with respect to oriented tape production, particularly slit-film lines, the preferred draw ratio in producing the fibrillation resistant isotactic polypropylene tapes is at least 4.5:1. At these higher draw ratios, isotactic polypropylene polymer tapes prepared using metallocene catalyst show a greater resistance to fibrillation and a higher elongation at break than those prepared using Ziegler-Natta catalyst. At draw ratios of at least 6:1, a significant difference in the shrinkage of the polymer tapes was observed. At draw ratios of at least 7:1, a fairly large difference in the tenacities at maximum elongation of the two materials resulted.

In one particular preferred embodiment, the process includes drawing the tape to a draw ratio of at least 5:1 to produce a tenacity at maximum elongation of at least about 6 grams per denier. In another aspect of the invention, the tape is drawn to produce an elongation at break of greater than about 12.0%. In another aspect of the invention, the above process is used to produce slit-film tapes, where each of said plurality of individual drawn tape segments each have a width within the range of about 0.1 cm to about 0.5 cm, with a preferred width within the range of about 0.1 cm to about 0.3 cm.

Having described specific embodiments of the present invention, it will be understood that modifications thereof may be suggested to those skilled in the art, and it is intended to cover all such modifications as fall within the scope of the appended claims.

1. A fibrillation resistant polymer tape comprising:
(a) an elongated tape segment prepared by the process of i) heating and extruding an isotactic propylene polymer produced by the polymerization of propylene in the presence of an isospecific metallocene catalyst to produce an isotactic polypropylene film; and ii) forming the film into at least one tape segment by drawing the tape segment in at least one direction at a draw ratio of at least about 4.5:1; and
(b) the tape segment being characterized by a lateral resistance to fibrillation that is greater than the lateral resistance to fibrillation of a tape segment produced under the conditions specified in subparagraph (a) from an isotactic polypropylene having an isotacticity of 96% rnmmm pentads,:produced by a supported Ziegler-Natta catalyst in the form of titanium tetrachloride on a magnesium chloride support having a titanium content of 2.5 wt. %.

2. The tape of claim 1 wherein the tape segment is drawn to a ratio of at least about 6:1.

3. The tape of claim 1 wherein the tape segment is drawn to a ratio of at least about 7:1.

4. The tape of claim 1 wherein the tape segment is drawn to a ratio within the range of about 4.5:1 to about 12:1.

5. The tape of claim 1 wherein the isospecific metallocene of the metallocene catalyst is characterized by the formula:
R″(C₅(R′)₄)₂MeQₖ
wherein each (C₅(R′)₄) is a substituted cyclopentadienyl ring; each R′ is the same or different and is a hydrogen or hydrocarbyl radical having 1-20 carbon atoms; R″ is a structural bridge between the two (C₅(RD₄) rings being in a racemic configuration relative to Me, and R′ is selected from the group consisting of an alkylene radical having 1-4 carbon atoms, a silicon hydrocarbyl radical, a germanium hydrocarbyl radical, a phosphorus hydrocarbyl radical, a nitrogen hydrocarbyl radical, a boron hydrocarbyl radical, and aluminum hydrocarbyl radical; Me is a group 4, 5 or 6 transition metal as designated in the Periodic Table of Elements; each Q is a hydrocarbyl radical having 1-20 carbon atoms or is a halogen; and 0≦k≦3.

6. The tape of claim 1 wherein the drawn tape segment has a width within the range of about 0.1 cm to about 0.5 cm.

7. The tape of claim 1 wherein the drawn tape segment has a width within the range of about 0.1 to about 0.3 cm.

8. The tape of claim 1 wherein the drawn tape segment has a thickness of from about 200 to 5000 denier.

9. The tape of claim 1 wherein the tape segment is drawn in the longitudinal direction.

10. The tape of claim 1 wherein the drawn tape segment has a tenacity at maximum elongation of at least about 6 g/denier.

11. The tape of claim 1 wherein the drawn tape segment has an elongation at break of greater than about 12%.

12. A fibrillation resistant tape comprising:
(a) an elongated tape segment prepared by the process of
(i) heating and extruding an isotactic propylene polymer produced by the polymerization of propylene in the presence of an isospecific metallocene catalyst, the metallocene of the metallocene catalyst being characterized by the formula:
R″(C₅(R′)₄)₂MeQₖ
wherein each (C₅(R′)₄) is a substituted cyclopentadienyl ring; each R′ is the same or different and is a hydrogen or hydrocarbyl radical having 1-20 carbon atoms; R′ is a structural bridge between the two (C₅(R′)₄) rings being in a racemic configuration relative to Me, and R″ is selected from the group consisting of an alkylene radical having 1-4 carbon atoms, a silicon hydrocarbyl radical, a germanium hydrocarbyl radical, a phosphorus hydrocarbyl radical, a nitrogen hydrocarbyl radical, a boron hydrocarbyl radical, and aluminum hydrocarbyl radical; Me is a group 4, 5 or 6 transition metal as designated in the Periodic Table of Elements; each Q is a hydrocarbyl radical having 1-20 carbon atoms or is a halogen; and 0≦k≦3; and
(ii) forming the film into at least one tape segment by drawing the tape segment in the machine direction at a draw ratio of at least about 4.5:1; and
(b) the tape segment being characterized by a lateral resistance to fibrillation that is greater than the lateral resistance to fibrillation of a tape segment produced under the conditions specified in subparagraph (a) from an isotactic polypropylene having an isotacticity of 96% mmnm pentads, produced by a supported Ziegler-Natta catalyst in the form of titanium tetrachloride on a magnesium chloride support having a titanium content of 2.5 wt. %.

13. The tape of claim 12 wherein the tape segment is drawn to a ratio within the range of about 5:1 to about 12:1.

14. The tape of claim 12 wherein the drawn tape segment has a thickness ranging from about 200 to about 5000 denier.

15. The tape of claim 12 wherein the drawn tape segment has a width within the range of about 0.1 cm to about 0.5 cm.

16. The tape of claim 12 wherein the drawn tape segment has a tenacity at maximum elongation of at least about 6 g/denier.

17. The tape of claim 12 wherein the drawn tape segment has an elongation at break of greater than about 12%.

18. The tape of claim 12 wherein the drawn tape segment has a width within the range of about 0.1 cm to about 0.3 cm.
